(19) United States
(12) Patent Application Publication
(10) Pub. No.: US 2017/0066214 A1
(43) Pub. Date: Mar. 9, 2017

(54) Box finishing machines

(71) Applicant: Yury Polikov, Pikesville, MD (US)

(72) Inventor: Yury Polikov, Pikesville, MD (US)

(73) Assignee: Sun Automation, Inc., Sparks, MD (US)

(21) Appl. No.: 14/756,362

(22) Filed: Sep. 4, 2015

(51) Int. Cl. B31B 1/36

(52) U.S. Cl. CPC B31B 1/36; B31B 2201/2637

(57) ABSTRACT

A corrugated box finishing machine including a plurality of vacuum belts for moving flat box blanks or “boards” along a horizontal path for use as either a die-cutting machine or a flexo-folder-gluer machine. A folding mechanism at the opposite sides of the machine has an active position where it folds parts of the boards as in a flexo-folder-gluer machine, and an inactive position spaced from the path of conveyance and the boards to accommodate boards which are not to be folded.

### FIELD OF THE PRESENT INVENTION

This invention relates to the field of production of corrugated paper boxes, specifically improvements in finishing machines and related methods.

### BACKGROUND OF THE INVENTION

Typically there are two different types of corrugated box finishing machines: one includes what is sometimes called in the art, a Flexo-folder-gluer and the other a Die Cutter. Examples of such machines may be found in U.S. Pat. Nos. 4,254,692 and 5,827,162.

Typically, a flexo-folder-gluer machine performs its functions in the following order: flat corrugated boards of blanks are fed one at a time; printed with one or more ink colors; scored, slotted and trimmed; die cut; glued and folded; counted and stacked. A conveyor ordinarily receives a corrugated box blank with four side-by-side panels, separated from one another by longitudinal creases and slots, with a glue tab associated with one of the outboard panels. The gluer mechanism is positioned at the entrance of the conveyor and applies the necessary amount of glue to the glue tab. A folding mechanism attached to both sides of the conveyor folds the side panels of the corrugated sheet 180° and creates a folded box. The folded boxes are then discharged into a standard format counter-ejector, which counts the folded boxes and creates bundles of the folded boxes. The standard format counter-ejector is designed to accept the folded corrugated boxes and is typically 6″ to 12″ (inches) wider than half the size of the widest box dimension across the main frames of the conveyor.

The other finishing machine called a die cutter does not include a folding mechanism and a gluer and typically performs its functions in the following order: flat corrugated boards are fed one at a time; printed with one or more ink colors; die cut; counted and stacked. Specifically, after exiting the die cut unit the boards enter a stacker, which moves the boards by a conveyor (typically a belt conveyor), and counts and creates bundles of the boards.

An object of the present invention is to provide a novel and improved corrugated box finishing machine that may be converted to serve as either a flexo-folder-gluer machine or a die cutter machine.

### SUMMARY OF PREFERRED EMBODIMENT OF THE PRESENT INVENTION

In summary, a preferred embodiment of the present invention includes a box finishing machine that may be converted to a flexo-folder-gluer machine or a die cutter machine. It includes a conveyor for moving the corrugated boards along a generally horizontal path and folding members which may be conventional, helical, rails positioned along opposite sides of the conveyor for movement in accordance with the present invention between a raised, inactive position and a lower active position for engaging and folding side panels of the boards as they are conveyed along the path. If it is desired to convert the machine to a die cutter, an actuator is energized to move the folding members to the raised, inactive position so that no folding of the boards occurs as they are moved through the machine. If it is later desired to run a job requiring folding of the panels of the boards, the actuator is energized to lower the folding members to the active position where they will engage the panels of the boards and fold them on to the main body of the boards as they are conveyed along the path.

### DESCRIPTION OF THE DRAWINGS

FIG. 1 is a perspective view of a box finishing machine constituting a preferred embodiment of the present invention and set to operate as a flexo-folder-gluer for production of folded boxes;

FIG. 2 is a side view of the machine of FIG. 1 showing a folding mechanism positioned in a lower active position below the path of box travel for folding board panels;

FIG. 3 is a perspective view of the machine converted for the production of die cut boxes;

FIG. 4 is a side view of the machine of FIG. 3 showing the folding mechanism in an upper inactive position above the path of box travel;

FIG. 5 is a fragmental elevational view of three different adjusted positions of folding members used to fold board panels when in the active position below the path of travel of the boards;

FIG. 6 is a plan view of a board of the “folded” type depicted in FIGS. 1 and 2 prior to being transported and folded through the machine; and

FIG. 7 is a plan view of a board of the “die cut” type depicted in FIGS. 3 and 4, and

FIG. 8 is a plan view of an adjustment mechanism for adjusting main and auxiliary conveyor belts included in the machine for moving the boards.

### DETAILED DESCRIPTION OF THE INVENTION

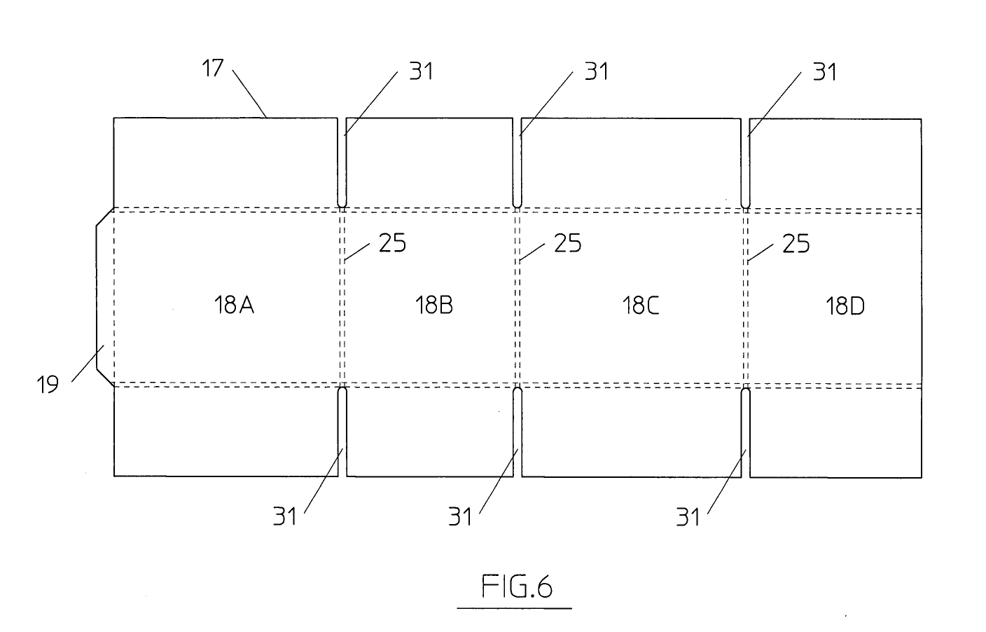

Referring to the drawings in details, there is shown for illustrative purposes a box finishing machine embodying the present invention including side frames 10; main vacuum belts 11 of a conveyor to move the corrugated sheets or boards 17 along a generally horizontal path. Sets of frames 12 rollable on rails 39 by means of electric motor (not shown) are provided to adjust the horizontal lateral position of the side frames 10 and main vacuum belts 11, depending on the size of the corrugated board 17 (depicted in FIG. 6) after its panels 18A, 18B are folded.

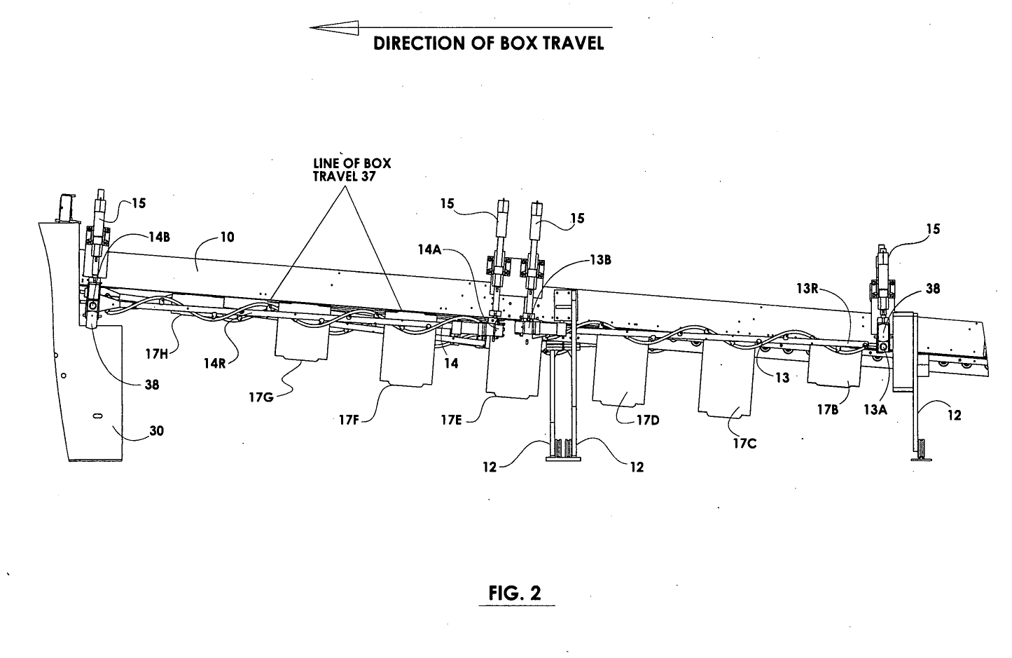

In the preferred embodiment shown this folding is accomplished by folding members or rails disclosed in the aforementioned U.S. Pat. Nos. 4,354,692 and 5,827,162 and including a pair of upstream helical folding rails 13 (first 90° of fold), and a pair of downstream helical folding rails 14 (second 90° of fold). Each folding rail 13, 14 is rotatable by means of a servo motor 16 about an axis through an axial rod 13R and 14R to which the rails are fixed respectively. At the entrance and exit of each folding rail 13, 14 there are mechanisms to adjust their positions. Referring to FIG. 2 at points 13A (entrance of folding rails 13) and 14B (exit of folding rails 14), the rails may be adjusted in a horizontal direction transverse to the conveyor path in an amount up to about nine inches. This adjustment is effected by conventional electric linear actuators 38, having extendable and retractable shafts 38S. This adjustment is made to accommodate boxes (boards) of different dimensions.

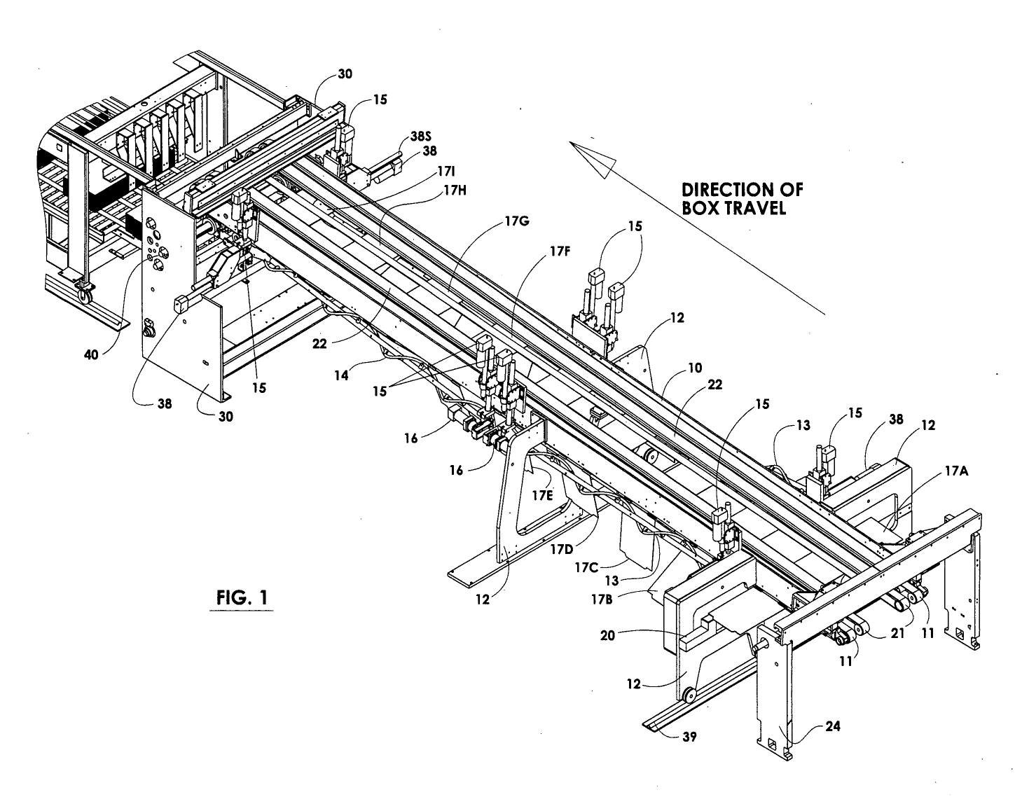

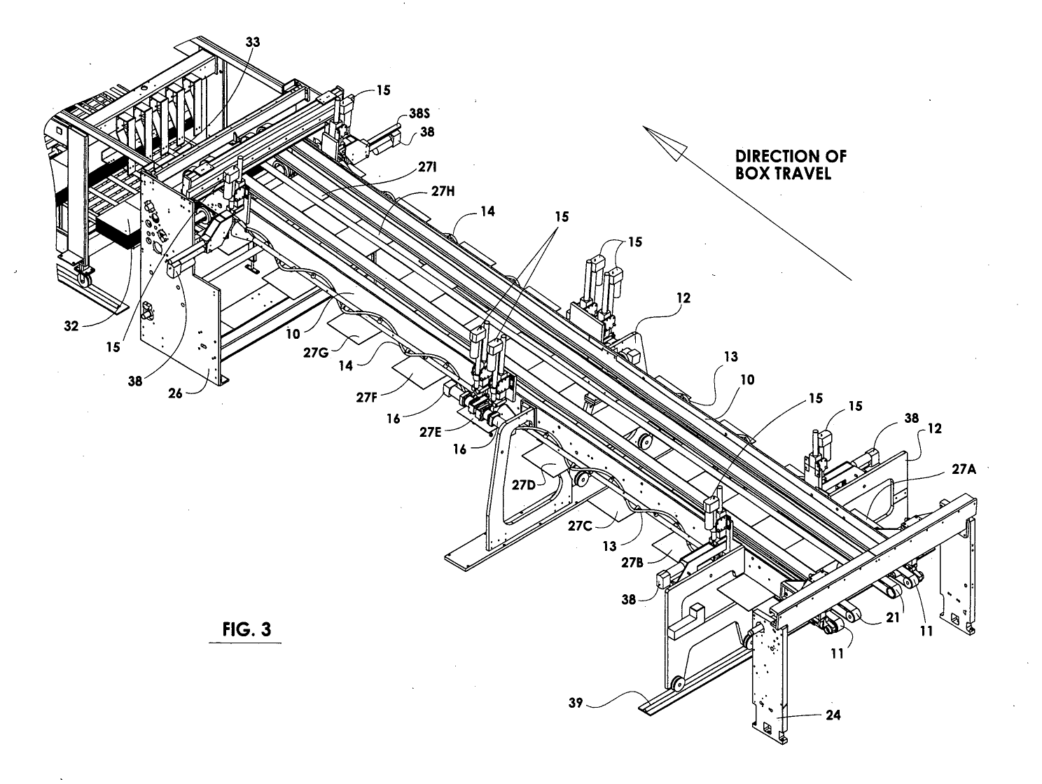

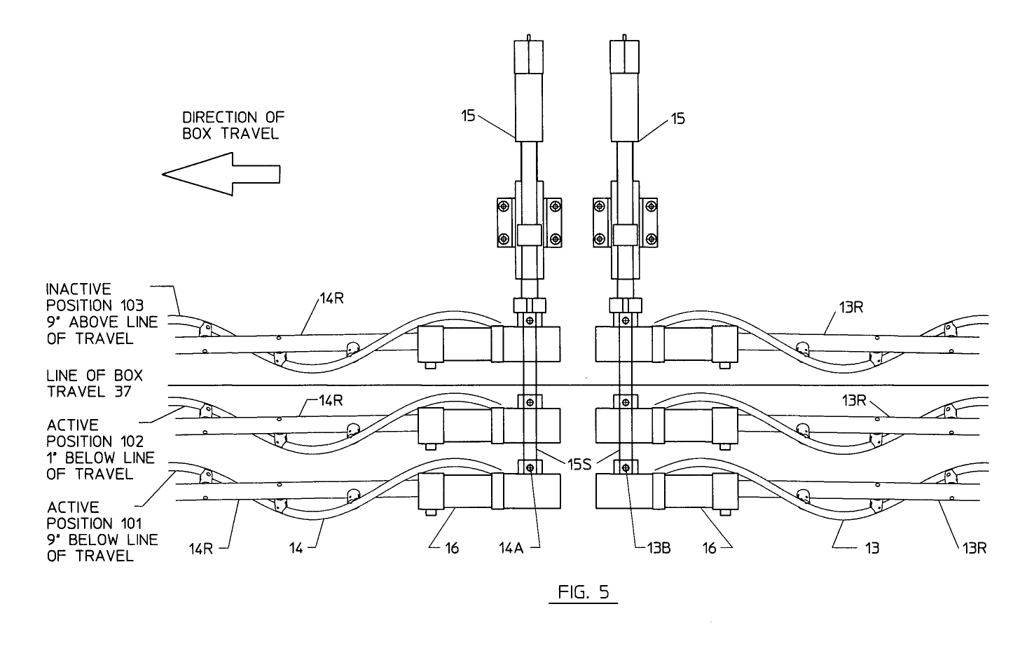

Referring to FIGS. 1, 2, 3 and 5, in accordance with the present invention the machine may be converted from a flexo-folder-gluer to a die cutter machine and vice versa by employing folding rails, 13, 14 that are adjustable between an active position (FIGS. 1, 2, 5) where they engage and fold the board panels as shown in FIGS. 1 and 2 and an inactive position (FIGS. 3 and 5) where they are spaced from the path of travel and the boards enabling the machine to be used as a die cutter machine where folding of the board panels is not effected. In the preferred embodiment the rails 13 and 14 are movable up to about nine inches (9″) above the path of board travel 37 to an inactive position or nine inches (9″) below the path of board travel 37 to an active position. This movement may be effected in any suitable manner such as the shown linear actuator 15 having extendable and retractable shafts 15S (FIG. 5) connected to the helical rails 13, 14 through their axial rods 13R, 14R. In the preferred embodiment the active and inactive positions of the folding rails 13, 14 may be adjusted between zero and nine inches depending on the type and dimension of the boards being processed. When the folding rails are in the inactive position they will be spaced from the boards conveyed along the path. When in the active position the folding rails will fold the boards as shown in FIGS. 1 and 2.

When the machine is in the flexo-folder-gluer mode, glue is applied to tab 19 of the boards by a conventional gluer 20 as shown for example in FIG. 1.

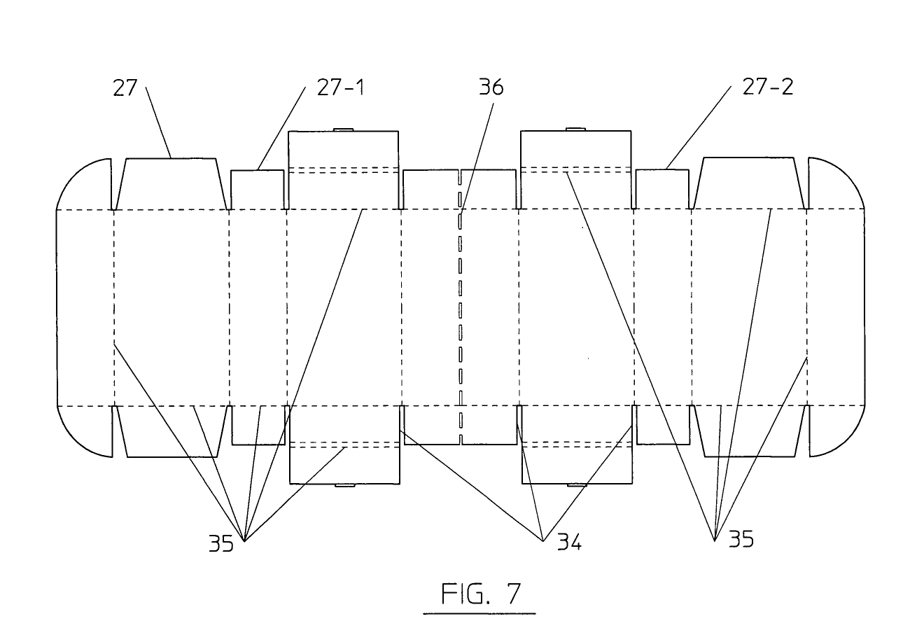

As shown in FIGS. 1 and 3 the boards are supported and moved along a horizontal path by main vacuum belts 11 on opposite sides of the machine as is well known in the art. However in accordance with another feature of the present invention, additional auxiliary vacuum belts 21 are provided to improve conveyance of the boards as well as the quality of the folds. Although not shown, one or three or more auxiliary belts 21 may be used on either side of the main belts 11. Auxiliary belts 21 are movable transversely of the conveyance path to adjust their position depending on the type and/or size of the boards being processed. When two or more boards (such as shown at 27-1 and 27-2 in FIG. 7) are being processed together (termed “multiple outs” in the art) the auxiliary belts 21 are moved into the desired position to provide improved support for both boards 27-1 and 27-2.

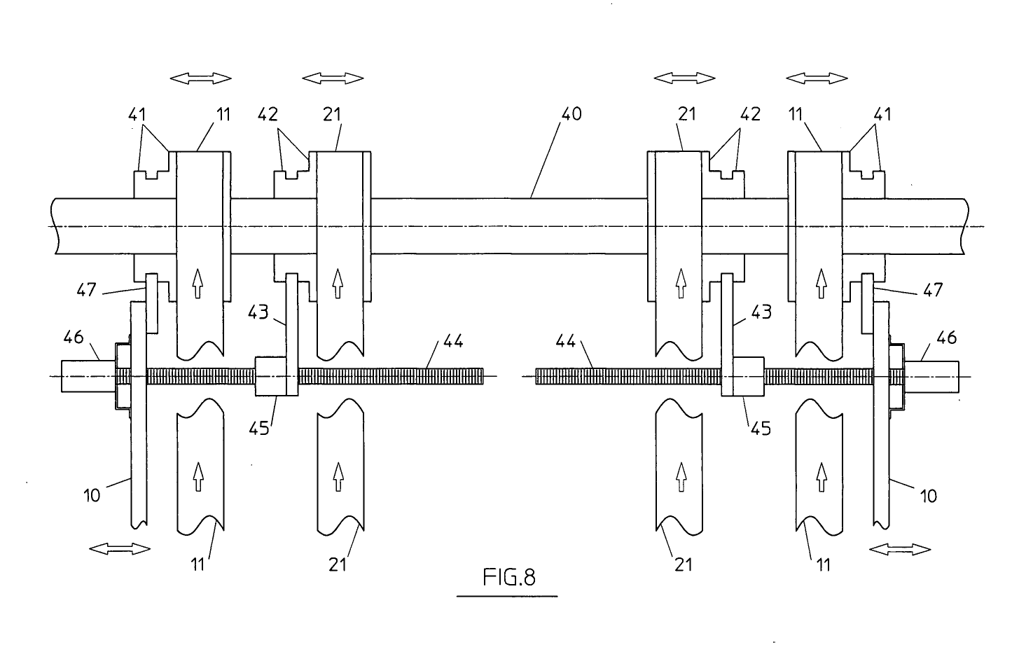

The mechanism to adjust the transverse positions of the main and auxiliary vacuum belts is shown on FIG. 8. Power shaft 40 is supported by bearings in the frames 30 of the folder exit unit and is connected to the main power train of the machine (gears not shown) to be rotated thereby. Power shaft 40 transfers power to the drive pulleys 41 and 42 through a long key (not shown). Pulleys 41 and 42 have the ability to slide laterally on the shaft 40 into the desired adjusted position.

Main belts 11 are driven by pulleys 41. Yoke plates 47 are attached to the main frames 10 and fit into a slot in pulleys 41. The pulleys 41 move laterally on the shaft 40 as the main frames 10 are moved by frames 12.

Auxiliary belts 21 are driven by pulleys 42. Yoke plates 43 are attached to the threaded hubs 45 which are engaged with threaded screws 44. Threaded screws 44 are driven by the electric motors 46 which are attached to the main frames 10. As the motors 46 rotate the position of the pulleys 42 changes relative to the position of pulleys 41.

With reference to FIG. 1 and FIG. 2, the sequence of operations when manufacturing folded corrugated boxes is as follows: The non-folded box depicted in FIG. 6 with four side-by-side panels 18A, 18B, 18C and 18D separated from one another by longitudinal creases 25 and slots 31 and with a glue tab 19 associated with one of the outboard panels, is discharged to the conveyor by a folder entrance unit 24. Main vacuum belts 11 are positioned to assist folding along longitudinal creases 25 and slots 31 of box 17. The folding rails 13, 14 are positioned by the linear actuators 15 and 38 in or between active positions 101 and 102 depicted in FIG. 5 to contact and fold box panels 18A and 18D upon rotation of the rails 13, 14 by servo motors 16. Auxiliary vacuum transport belts 21 are laterally positioned across the travel path by the mechanism shown on FIG. 8 described above to assist with conveyance of the box. Glue applicator 20 is operational and applies the necessary amount of glue to the glue tab 19 of box 17. The sheets 17 are moved along the direction of travel by a set of vacuum belts 11 and a set of vacuum belts 21. The two outboard side panels 18A and 18D are folded 180° by folding rails 13, 14. The folded and glued boxes 17 are discharged into a wide format counter-ejector 26 which is designed to be four to twelve inches (4″-12″) wider than full width of the widest sheet 17 able to run through the machine. The wide format counter-ejector 26 counts the folded boxes 17 and forms the bundles 32, which are moved by a conveyor 33 away from the machine.

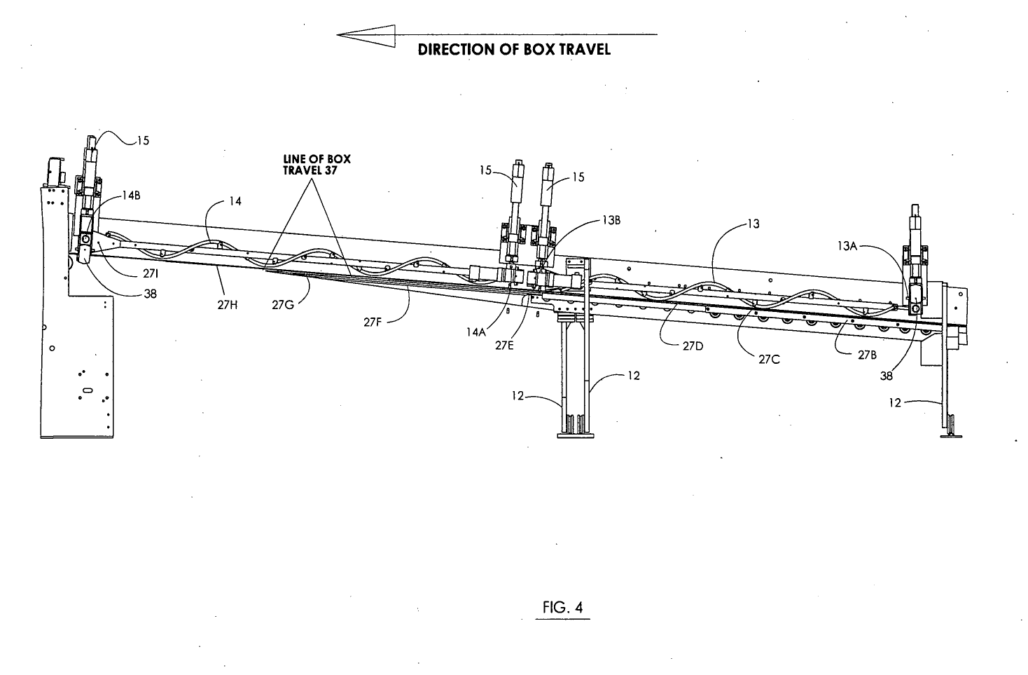

Referring to FIG. 3 and FIG. 4, the sequence of operations when manufacturing die-cut corrugated boxes is as follows: The die-cut sheet 27 depicted in FIG. 7 with several panels separated from one another by slots 34, longitudinal and transverse creases 35 and serrated lines 36, is discharged to the conveyor by a folder entrance 24. Main vacuum belts 11 and auxiliary transport belts 21 are laterally positioned to assist with the transfer of the die-cut sheets 27. Folding rails 13, 14 are moved by the linear actuators 15 into a position 103 depicted in FIG. 5 above the line of box travel 37 of the sheets 27, and are not rotating (disengaged). The glue applicator 20 is non-operational. The die-cut sheets 27 are moved along the direction of travel by vacuum belts 11 and 21 and enter into a wide format counter-ejector 26 which counts the die-cut boxes 27 and forms the bundles 32 that are moved by a conveyor 33 away from the machine.

The folding mechanisms of this invention are shown as “down folders”, that is, where the folding mechanism 13, 14 acts from below the moving box board to fold the box panels. This invention also embraces “up folders” (not shown), that is, where the folding mechanism acts from above the moving board to fold the box panels. In this case, when manufacturing the die-cut boxes, the folding mechanism is disengaged by moving into an inactive position below the line of travel of the corrugated boxes.

Although preferred embodiments of the present invention have been shown and/or described above, it will be apparent to those skilled in the art that obvious variations of the present invention disclosed herein will be encompassed by the scope of this invention as defined in the appended claims. For example, it should be obvious to one skilled in the subject art that the machine of the present invention may include a conveyor that moves the boards along an inclined path rather than a horizontal path as shown and described.

What is claimed is:

1. A box finishing machine including a conveyor for moving box boards along a path, a folding mechanism including a folding member engageable with a portion of a board during conveyance of said board along said path, and means mounting said folding mechanism for movement of said folding member between an active position for engaging and folding said board portion and an inactive position spaced from said path for enabling the machine to accommodate boards that do not require folding while being conveyed along said path.

2. The machine defined in claim 1 wherein said inactive position of said folding member is located above said path.

3. The machine defined in claim 2 wherein said inactive position of said folding member is in a range of up to nine inches above said path of travel.

4. The machine defined in claim 2 wherein said active position of said folding member is located below said path.

5. The machine defined in claim 4 wherein said active position of said folding member is up to about nine inches below said path.

6. The machine defined in claim 1 including a plurality of vacuum belts for moving the boards along said path, said belts including outer belts on opposite sides of said machine and at least one auxiliary belt located between said outer belts, said auxiliary belt being adjustable transversely of said path of travel to provide desired support for the boards.

7. The machine defined in claim 4 including a plurality of vacuum belts for moving the boards along said path, said belts including outer belts on opposite sides of said machine and at least one auxiliary belt located between said outer belts, said auxiliary belt being adjustable transversely of said path of travel to provide desired support for the boards.

8. The machine defined in claim 6 including a rotatable drive shaft, a pulley mounted on said drive shaft with said auxiliary belt being trained about said pulley to be driven thereby, a yoke connected to said pulley to move it along said drive shaft into an adjusted position, and means for moving said yoke transversely of said path to adjust the position of said pulley and said belt driven thereby.
